(19) United States
(12) Patent Application Publication
(10) Pub. No.: US 2004/0049969 A1
(43) Pub. Date: Mar. 18, 2004

(54) Permanent and interchangeable rigid and flexible blades affixed to two hook tandem hooks and hookmasters for side to side and vertical oscillating lures, pin weights pin floats optional weed guard

(76) Inventor: John H. Rudolph, Laguna Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/602,999

(22) Filed: Jun. 24, 2003

Related U.S. Application Data
(60) Provisional application No. 60/393,583, filed on Jul. 5, 2002.

(51) Int. Cl. A01K 85/00

(52) U.S. Cl. 43/42

(57) ABSTRACT

A soft artificial fishing bait having two flexible front intersecting planes, which provide an up and down motion. The flexible blades bend back, when contacting an impediment, allowing the lure to flip over or around the obstruction. Two-blade interchangeable lure can be attached to a tandem hook or a flat blade hook accessory, a part of the invention, which I call a “Hookmaster”. A Pin Weight or a Pin Float, also of the invention, is often necessary to balance different lure shapes and sizes to insure maximum lure oscillation. A separate specially bent stainless steel wire weed guard is inserted into the soft bait body with loop end engaged, under tension, with hook barb to reduce possibility of hook becoming fouled. The top exterior angled portion of wire guard is flexed downwardly to retain tension so loop end portion will surround hook barb, so that lure can be fished in cover. Proper insertion of bait and pin weight or weights will make a single bladed lure oscillate in a pulsing up and down fish attracting action. Attached removable blades allow tandem hooks or “Hookmasters” to exhibit action to both live and artificial baits.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

### FIELD OF THE INVENTION

This invention relates generally to live or soft artificial fishing baits and lures that have fish enticing movements and can be fished successfully in reeds, brush, rocks and other obstructions, where the fish live and feed. The invention also relates to the shape and location of the two flexible or rigid planes that causes lures to exhibit a unique fish enticing up and down, frog like, pulsating action. The invention also relates to the physical properties, as too how they float and sink as they are pulled through the water.

### DESCRIPTION OF THE PROBLEM

The critical lure balance point of up and down lures is provided by the location of the fish line snap hole in Hookmaster at rear of large hole in front portion on vertical centerline of lure having double blades. Special Pin Weights and Pin Floats can be inserted or removed from bait body at will. Conventional soft artificial baits exhibit little if any action. In order to make conventional soft artificial baits and live baits be more appealing to the fish, some type of enticing action is necessary.

### DESCRIPTION OF THE PRIOR ART

Carnivorous fish eat frogs, shrimp, and other live food that move in an up and down pulsating movement. There is a need for a lure that simulates the shape and action of this natural forage. The subject of this invention has provided both characteristics by providing a soft artificial fishing lure, having two flexible planes, which form lips on the anterior end that intersect at a horizontal angle between 75 degrees and 105 degrees, which provide up and down pulsating action. Some conventional soft baits have a small amount of flutter or no fish enticing action at all, especially an up and down pulsating action. A two-bladed accessory of the invention, permanently attached to a two hook tandem hook or Hook Apparatus with a live or soft artificial frog impaled on the top hook portion exhibits an up and down pulsating action. A weight or float permanently molded or bonded on the blunt end of a straight pin, is selectively inserted into the bait to aid in controlling the attitude of a live or soft artificial bait as it floats, sinks, trolled or retrieved after a cast. A barb is formed on some pin Weights and Pin Floats to insure said weights and floats are not dislodged from the bait, due to the thrashing of a fish, or when bumping into reeds, brush, or other obstructions. Soft bait is made snag proof with specially bent separate optional stainless steel wire weed guard, inserted through bait soft body. Said guard extends rearwardly and is flexed to surround and protect the hook barb from becoming impaled on unwanted obstructions in the water. Flexible single and rigid diving blades permanently affixed to tandem hooks or Hookmasters, along with a wire weed guard provide optimal fishing in impediment filled water. Permanently attached removable interchangeable rigid single diving lips are generally used in impediment free water. Flexible and rigid, replaceable interchangeable, single diving lips attached to a two hook tandem hook or a Hook Apparatus will make impaled live and soft artificial baits oscillate side to side, aid lips are selectively inserted, as to the kind and amount of obstacles in the water. Modifications of two-hook tandem hook attached to a removable interchangeable two-bladed accessory, will make correctly impaled live or soft artificial bait, such as frogs, oscillate up and down. A Pin Weight or Pin Float inserted into the side of attached soft bait on a two-bladed lure will cause lure to rotate 90 degrees and will then exhibit a side-to-side oscillation.

The following art defines the present state of this field.

Bray, Alan V. U.S. Pat. No. 6,948,379 “High Density Composite Materials”, teaches that Tungsten in various percentages and micron sizes is one of the many acceptable materials as a substitute for toxic lead fishing weights. Zirconium Silicate included in this invention has a lower specific gravity than tungsten, so size of fishing weight must be of larger. Peterson,

Lyle M. U.S. Pat. No. 6,164,006 “Fishing Lure With Interchangeable Tail” is an interesting and practical fishing lure concept, however, the lure activating bill is probably rigid, therefore, is not snag proof as would be a lure with a flexible lip, so is restricted to obstacle free water.

Itoh, Koichi U.S. Pat. No. 5,566,498 “Mechanism for Moving and Holding Balance Weight in Lure”, teaches that weight is adjusted in lure by moving weight along a guide. This moveable weight aids in angle of lure descent and keeps the lure running upright. The weight cannot make it oscillate partially on its side, to simulate the motion of an injured baitfish. Pin weights or Pin Floats, optionally inserted in lure body, change attitude of lure as it sinks or, when pulled through water.

Trnka, Barry U.S. Pat. No. 5,134,799 “Fishing Lure”, consists of. one or more ball or pellet weights in passages, held in place by friction to effectively simulate bait fish swimming movements. These weights are restricted to the area inside tubes and are limited as to their versatility. The Pin Float of the invention is inserted most anywhere on the soft artificial bait body to develop maximum action. Both Pin Weights and Pin Floats can be inserted in the same bait body. A worm could be made to stand on end by inserting a Pin Float in the front end and inserting a Pin Weight on the opposing end.

Rinkor, David E. U.S. Pat. No. 5,531,042 “Fishing Sinker Having Adjustable Weights”, explains that different weight fishing sinkers are necessary for different fishing conditions. The weight is connected to the fishing line, which have little or no affect on lure action, only the depth of the lure.

Gardner, John Christopher, U.S. Pat. No. 5,786,416 “High Specific Gravity Material,” describes at least one thermoplastic polymer component and matrix particles of high specific gravity weight of greater than one, in the range of eight to twelve, however there was no mention of placing this weight on a versatile pin and inserting it into a soft lure body.

Rudolph, John H., U.S. Pat. No. 6,141,900, “Flexible Oscillating Fishing Lure System,” contains lure with flexible diving lip, a tandem two hook fish hook, and adjustable hook weights that attach to hook shank. A two hook tandem hook with either flexible or rigid activating lip, or a double lip permanently attached, provides side to side or up and down oscillation and also provides the option of fishing with either live or artificial bait. The Patent makes no reference to a two hook tandem hook having flexible or rigid diving lips permanently attached to said hook, to create a side to side or up and down oscillation and to have said lips removable and be interchangeable. The Patent did not include a double lipped or bladed lure having an up and down pulsating action. The adjustable hook weights do keep the lure from spinning, as it is being trolled or retriever. The close cell foam insert in said patented bait, does help the lure to float or run higher in the water, but is limited to one hole in anterior end to determine what the lure can do. Both Pin Floats and the Pin Weights of the invention are more versatile to make a lure run in the desired manner. One or more Pin Floats or Pin Weights can be inserted into all parts of the bait body to create different movements at different depths

Eckenroth, Kevin R. U.S. Pat. No. 6,129,620, “Adjustable Buoyancy Fishing Float.” consists of an air chamber formed with convoluted bellows tube. Shaft glides at top and bottom of each tube. This float is typical of floats that are used on fishing line, not on the lure. There is no way to use this float on the bait of lure. There is no comparison between this buoyant float and the micro-balloon, close cell foam, and ground cork filled epoxy, Pin Float of the invention.

Rayburn, Walter U.S. Pat. No. 4,696,1125 “Casting Float With Line Stop,” is also a buoyant float with water filling means to add weight for better casting against the wind. It too has no affect on the lure as it moves through the water.

Huddleston, Samuel M. U.S. Pat. No. 6,212,818 “Soft Bait Fish Lure,” describes a soft bait fish, having front end portion of hard material with a weight molded inside. Weed guard is permanently attached at mid section of lure. Weed guard cannot be removed when fishing in clear water with no obstructions. A Hardheaded lure has a hard non-flexible diving lip, therefore, cannot be fished in cover, as a flexible lip of this invention can be fished. The weed guard being fixed cannot be removed without damaging the lure.

Jilling John U.S. Pat. No. 6,283,485 Method for “Producing Combination Fish Hook and Weed Guard Device,” is described as a weed guard permanently attached to a slot with an adhesive, such as Epoxy, therefore, weed guard must remain on hook, even, when fishing in impediment free water.

Luz, Robert J. U.S. Pat. No. 4,223,469. “Fishing Lure,” having permanently affixed flat bill portion and a pair of pivotally flat arm portions behind bill portion. Everything about this lure appears to be rigid, which is not obstacle proof, as are flexible baits with one or more flexible activating lips or blades and a weed guarded hook illustrated in this invention.

Ninomiya, Masaki U.S. Pat. No. 4,761,910 “Artificial Bait Device,” teaches that a weight is located in center portion of lure to aid in casting. The weight shifts during the cast to the posterior end of lure and shifts to a second position as lure is retrieved. The weight is confined to two basic locations, so lure will always have the same action. Pin Weights and Pin Floats of the invention can be inserted in different places in the bait body, which can change the oscillation and the depth the lure is desired to run. Clearly there is a need for such lures with life like fish attracting action, a hook, which will align and hold soft baits, jigs and other flexible lures securely and still be relatively simple and inexpensive to manufacture.

### SUMMARY OF THE INVENTION

To help solve the above stated problems an interchangeable flexible or rigid two-bladed accessory was developed. The front surface planes of the two lips intersect to form an angle between 75 degrees and 105 degrees, Approximately 90 degrees being preferred. Said double-lipped accessory is attached to a two-hook tandem hook or a Hook Apparatus on which the various baits are impaled. Fishing weights are generally attached to the line or molded on the front of a hook, which has very little or no affect as to promoting action to the lure, therefore, a unique weight or float concept was developed. They are molded on the blunt end of a straight pin, which is inserted into a specific portion of alive or soft artificial bait to change lure balance point and to produce the maximum fish enticing action. Straight pin may be bent for specific applications and may have a barb. Many fish feed along the shoreline, which is generally encumbered with reeds, brush, and rocks that foul and impede the natural motion of a conventional lure with rigid blade. Flexible blades bend backward and allow the lure to flip over or around the impediment and with the addition of a specially bent, optional, independent weed guard, the lure can be made relatively snag proof. Weed guard is properly inserted into bait body, when the top angled portion is flexed and under tension and loop is secure over hook barb. This position makes the lure virtually snag-proof. Wires extending through lure bottom surface are bent to the rear parallel to the bottom surface, to keep wire guard aligned and secure over hook barb. Single flexible or rigid diving lips are permanently attached to tandem hook and Hookmaster. Interchangeable single flexible or rigid diving lips having a rear hook-securing flange are optionally attached to tandem hooks and Hookmasters with a cotter pin inserted through a provided hole in side of flange. The above single diving lips or blades cause soft artificial baits to oscillate in a side to side action, however, when bait is properly inserted on a tandem hook or flat blade hook accessory of the invention and a pin weight or pin weights are properly attached, said lure can be made to exhibit a pulsating up and down motion.

The present invention consists of many interrelated parts, single lipped lures, double bladed lures, Pin Weights, Pin Floats, hooks, both tandem hooks and Hookmaster, Interchangeable double bladed accessories, attached to tandem hooks and Hookmasters, and an optional separate stainless steel spring wire hook weed guard. The lure exhibits two flexible planes interesting at an angle between 75 degrees and 105 degrees at the forward end of the lure. The flexible blades or lips divert the water, so that the lure oscillates in an up and down, frog-like, pulsating action. The flexible planes or lips easily bend on contact with an obstruction, allowing lure to flip over or around impediment. The up and down action is enhanced, when fish line eye on hook or hook apparatus is recessed into a large hole in bait front portion on bait vertical centerline and the intersection of the two intersecting flexible plane. Conventional soft artificial and most live baits move through the water like a straight stick. These baits can be activated, by being impaled on single or double-lipped accessories of the invention. Single diving lips cause lures to oscillate in a side-to-side manner. Double-lipped accessories cause soft artificial baits to move in an up and down action. Interchangeable lip accessories being more versatile are attached or removed from tandem hooks and Hook Apparatus with the same attachment means. The present invention also provides a live or soft artificial bait accessory, which controls the attitude of the bait as it sinks or floats, while being pulled through the water. Said accessory consists of a weighted or buoyant sphere or amorphous shaped material permanently bonded to the blunt end of a straight pin, similar to a sewing pin. The weight or float aids in eliminating unwanted lure spin. Location of Pin Weight inserted near or into the bottom portion of lure determines the attitude and how the lure sinks. Pin Weight inserted at bottom forward surface will sink lure front end first and will have the opposite action, when inserted into rear bottom portion. A Pin Weight properly installed will cause bait to sink more naturally often making little change in lure action More than one Pin Weight can be used to take a lure deeper and faster.

A Pin Float consists of the same general shapes as a Pin Weight and one or more Pin Floats can be inserted on or near bait top surface to cause a live or soft artificial bait to float or to suspend shallow. A pin weight inserted into the side of a soft two-lipped lure will cause lure to oscillate side to side. A second Pin Weight consists of a pin extending from either end of elongated solid ellipse. Front longer pin is inserted into a slit directed forwardly in soft artificial bait body, the body is stretched so that rear shorter pin can enter slit and insert to rear of slit. As body gets back to natural shape, the weight or float is adjusted to fit into slit properly. The Balance of an up and down oscillating lure is extremely critical. Pin Weights or Pin Floats properly inserted in the bait will insure maximum vertical action. The recent invention teaches certain benefits in construction and use, which gives rise to the objectives described below. A primary objective of the present invention is to provide live or soft artificial bait or lure having advantages not taught by the present art. A further objective is to provide such bait weight or float accessory that can be applied to or concealed within the bait to cause the bait to be snag resistant. Another objective is to cause live or artificial bait to appear more natural as it wiggles, swims, or swishes as it moves through the water. This is accomplished because bait is now correctly balanced. A still further objective is to provide such weight or buoyancy to make a lure or soft artificial bait to move in a predictable manner. A still further objective is to eliminate the weight molded on a conventional lead head fishhook. A Pin Weight is made environmentally friendly by using epoxy filled with Barium Sulfate, Iron Ferrite, or Zirconium Silicate, or can be molded from the generally used toxic weight material, lead. Pin Floats are also environmentally friendly, when molded from Epoxy filled with micro-balloons, or shaped close cell foam or ground cork, permanently bonded to the blunt end of a straight pin. A specially bent stainless steel wire weed guard is optionally inserted into soft fishing bait or lure body, so that loop end of weed guard surrounds hook barb. Exterior wire that extends through lure body is bent to the rear and parallel to the lure bottom surface. Top exposed wires are flexed to put tension on loop end to protect hook barb from snagging unwanted objects. Other features and advantages of the present invention will become apparent from the following more detailed description taken in conjunction with the accompanying drawings, which illustrate, by way of example, the principals of the invention. Color, shapes, size and action entice fish into striking. Many, conventional, soft artificial baits have little or no action. A flexible or rigid single diving blade or lip was permanently attached to a tandem hook or Hookmaster to provide action to those conventional baits. Easily attached or removed interchangeable diving blades were designed for tandem hooks or Hookmasters to gain more versatility, when fishing soft artificial baits in reeds, brush, rocks and in clear water.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIGS. 1A-1H are front elevational views showing Pin Weights including, in FIG. 1D, two parallel pins and, in FIG. 1F, a weight or float with a pin extending from each end, with one pin longer than the other, with the longer pin to be inserted forward in a bait.

FIGS. 1I-1L are front elevational views of Pin Floats with FIGS. 1J and 1K having two pins to hold to a lure more securely.

FIG. 2 is a side elevation Hookmaster showing hole located in projection at front bottom portion of Hookmaster, bait aligning and securing hook, holes for single and double bladed accessories, and optional hooks.

FIG. 3 Is a side view of a fish like shaped bait, having a simultaneously poured flexible diving lip impaled on top hook of a two hook tandem hook trailing a treble hook suspended by an “O” ring. A Pin Weight is inserted into the bottom forward surface, behind flexible diving lip. Hook eye penetrating single diving lip.

FIG. 4 is an elevation of a soft artificial frog like shape having two intersecting planes, blades or lips, forming an internal angle between 75 and 105 degrees. Said bait is impaled on front top hook of a two-hook tandem hook and trails a treble hook attached with an “O” ring. To insure proper lure balance and vertical oscillation for maximum action, a Pin Weight is inserted in lure on bottom front portion directly behind lower lip on the vertical centerline. A wire weed guard is inserted in bait body so that loop end portion of guard surrounds and contacts lower surface of hook barb. Leg supporting loop end is flexed and held under tension by angle of bent wire selectively inserted into the soft bait body. Portion of wire extending through bottom surface of bait body is bent to the rear and parallel to bottom surface. Another option of FIG. 4, illustrated in FIG. 5 is to attach a two bladed interchangeable flexible or rigid accessory to a Hookmaster so that a jig or other live or soft bait can exhibit a fish enticing action yet be quickly and easily attached or removed.

FIG. 4a is a sectional side view of section A-A, shown in FIG. 4c, showing the proportional length of the two vertical activating lips. Location of Pin Weight, legs, and feet and hook line eyehole on vertical centerline at intersection of flexible planes or lips.

FIG. 4b is a front view of FIG. 4 showing the two fronts up and down activating planes or lips and position of hook line eye at rear of large hole in double-bladed accessory forward end.

FIG. 4c is top view of FIG. 4 showing general contours of lure body and lips, also large hole in front lips, so that hook line eye can be recessed. Wire weed guard penetrating legs are shown spread. Section A-A is shown on longitudinal centerline.

FIG. 5 is a right side elevation of the general shape of a Hookmaster, which can be used for both single and double-lipped baits. Front portion showing attached interchangeable single flexible diving lip with securing hole. Also shows holes for optional hooks including treble, single weed less, and stinger hook suspended by an “O” ring.

FIG. 6 is one elevation of the shape of a two-hook tandem hook. This hook design is for double lip soft baits, as front hook shanks are straight.

FIG. 7 is a live worm or a soft artificial worm like shape impaled on a two-hook tandem fishhook with permanently bonded flexible or rigid diving lip. A ball shaped Pin float inserted on front end of worm. Front surface of Pin Float is centered over hook line eye. A stinger leader and hook are also illustrated.

FIG. 8 is a cotter pin used to secure interchangeable lip on a two-hook tandem hook and Hookmaster.

FIG. 9 is a mouse-like shaped soft bait with a simultaneously poured flexible diving lip, impaled on a Hookmaster. A Pin Float is concealed within the upper rear portion of lure body. A single large hook attached to the Hookmaster with an “O” ring in second hole from rear end. A weed guard is inserted into lure body top rear portion; prongs on guard are inserted on either side of Pin Float and Hookmaster. Long top exposed weed guard portion is flexed, so that loop end portion contacts bottom of hook barb and held in place under tension. Portion of weed guard that extends past bottom lure surface is bent rearwardly and parallel to the bottom body surface to keep weed guard aligned and securely attached.

FIG. 10 is an elevation of a jig. Front portion of soft flexible material, constricted center portion, and trailing feathers. Said jig is impaled on upper hook of two-hook tandem hook with an interchangeable single flexible diving lip. A pin Float is inserted into front end of jig above diving lip.

FIG. 11 is an elevation of a two-hook tandem hook with a permanently affixed rigid single diving lip. Hook shank extended behind top hook. Lower shank has hook eye at terminal end.

FIG. 12 is an elevation of a two-hook tandem hook with an interchangeable flexible single diving lip and rear hook shank eliminated from hook shown in FIG. 11.

FIG. 13 is a front elevation of general shape of interchangeable single flexible or rigid diving lip with attachment hole to be used with hook apparatus.

FIG. 14 is an elevation of interchangeable flexible single diving lip with hole in lip flange to secure lip on a Hookmaster with a cotter pin.

FIG. 14a is a side view of interchangeable rigid single diving lip showing two hole locations in rear flange to accept a cotter pin to secure either one or two hook shanks or a Hookmaster.

FIG. 14b is front view of either flexible or rigid diving lip showing slot to receive tandem hook or Hookmaster.

FIG. 15 is a side view of a two-bladed interchangeable flexible or rigid up and down action accessory, shown attached to a two-hook tandem hook. Front lower hook eye has two functions. It holes the lip accessory from moving rearwardly and can be fitted with an optional hook Front top hook aligns and secures bait. Rear hook is for catching fish.

FIG. 15a is same lip accessory as FIG. 15 with a different tandem hook configuration.

FIG. 15b is a top view of double lip accessory showing tapered hole, hook flange and segment of hook with hook eye recessed in hole behind front angled lips or blades.

FIG. 15c is a front view of double lipped accessory showing the large hole in front end with slot for tandem hook eye or front end of Hookmaster. Large hole in front of bait is necessary so it won't restrain double loop accessory from friction free up and down movement.

FIG. 16 is a Hookmaster attached to an interchangeable double bladed accessory, showing bait aligning and securing hook oriented above Hookmaster body and holes for attaching optional hooks. Hookmaster is attached to fishing line snap by a two-loop connector.

FIG. 17 is a line drawing of wire weed guard. Lower portion #59 is not bent until inserted through lure.

FIG. 17a is a perspective drawing of wire weed guard showing loop at upper end and inserted legs separated.

FIG. 18 is worm like shape with slit to receive Pin Weight or Pin Float with pins extending from each end.

FIG. 18a is worm like shape with open slit with Pin Weight or Pin Float installed, long pin at front end.

### DETAILED DESCRIPTION OF THE INVENTION

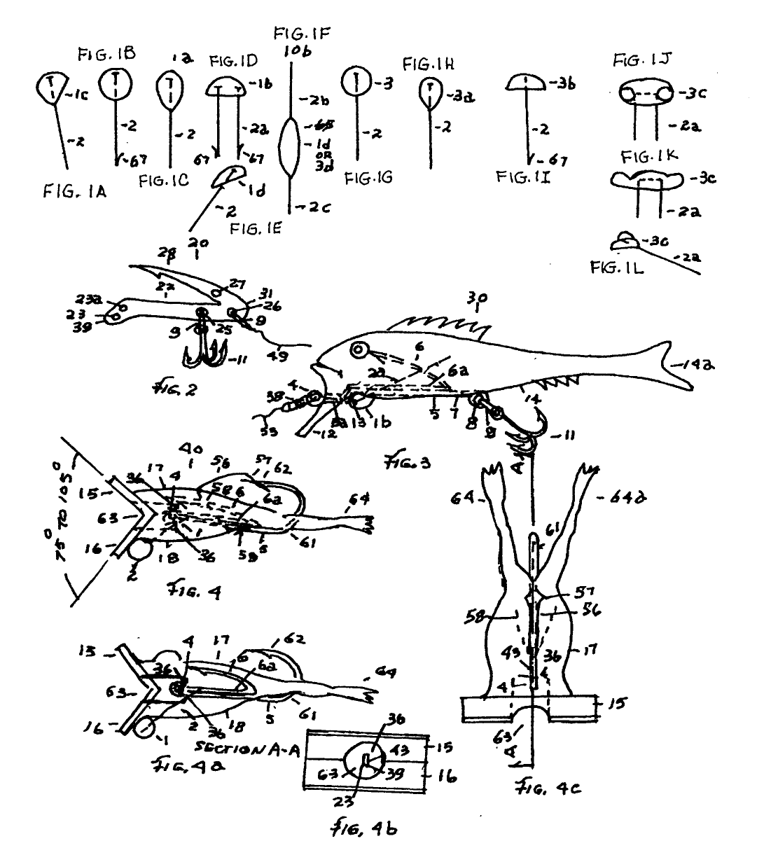

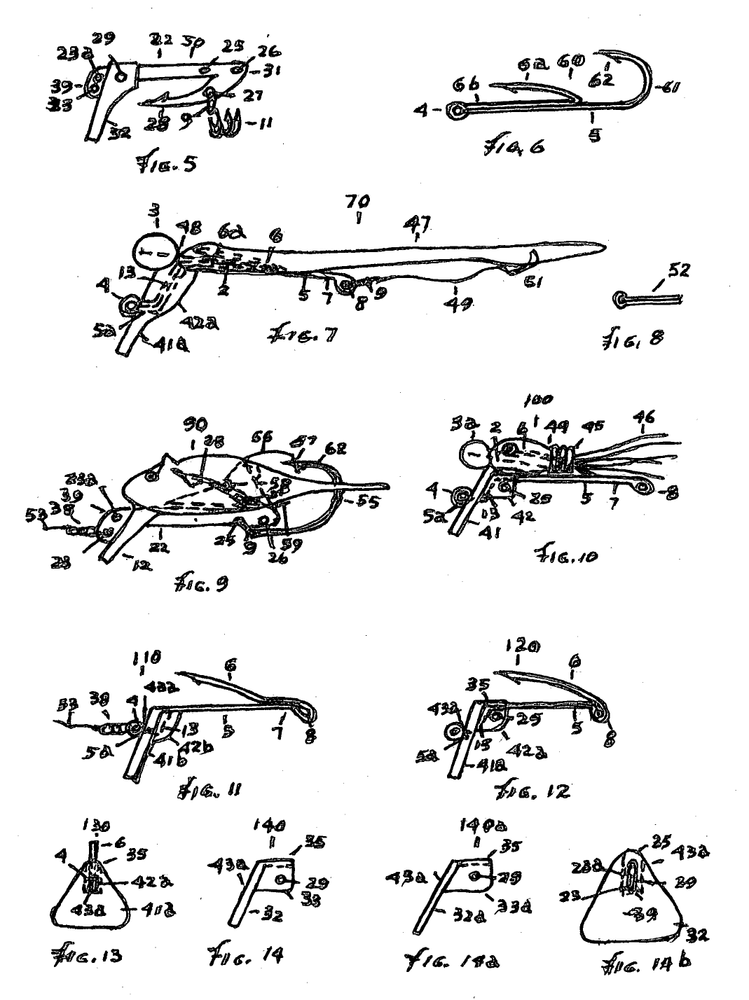

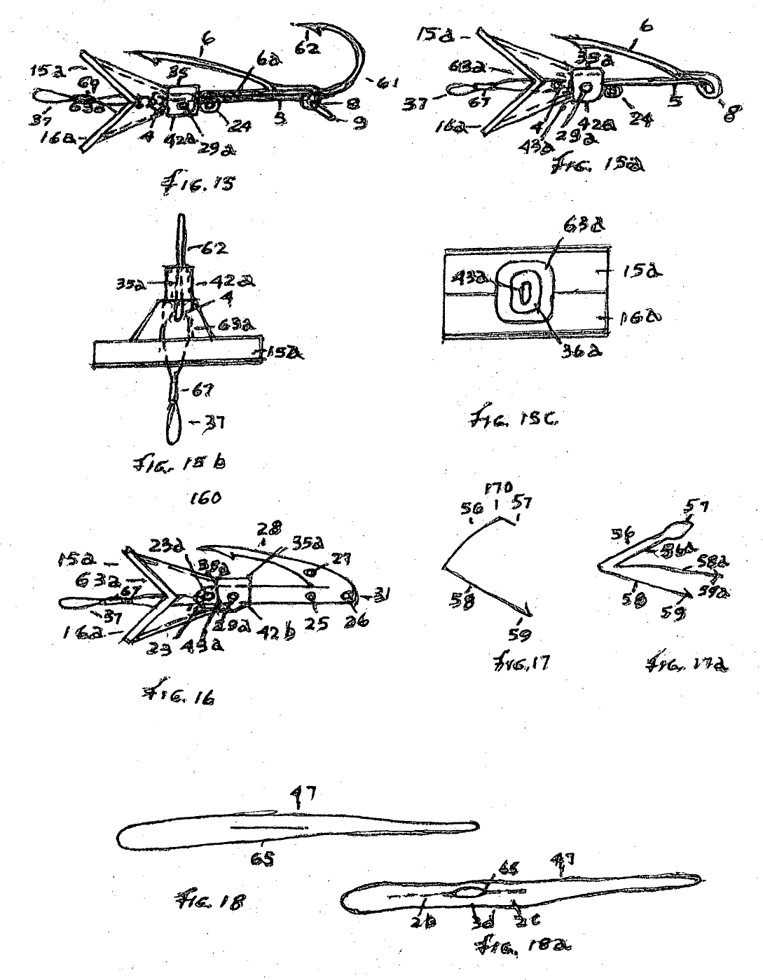

The described drawings illustrates the invention. A Pin Weight, FIGS. 1A-1H and collectively referred to herein by the numeral 10 and Pin Float referred to by numeral 10a and shown in FIGS. 1I-1L show some of the various shapes available. Pin Float 10a are used to enhance the bait action to increase the possibilities of catching fish and to gain the satisfaction of using a Pin Weight 10 or a Pin Float 10a properly, that you have outsmarted the fish. A Pin Weight 10 is comprised of two parts, a straight pin, similar to a sewing pin, and a weight molded from Epoxy with environmentally friendly fillers of Iron Ferrite, Barium Sulfate, Zirconium Silicate, or other heavy material or from toxic molten metal, such as Lead. A Pin Float 10a, similar in shape to the Pin Weight 10 in FIG. 1A-1H consists of the same straight pin 2 with Epoxy filled with micro balloons, ground cork, close cell foam, or other buoyant materials bonded to pin 2. Pin Weight 10 is inserted into soft plastic body 30 on the bottom surface 14 behind simultaneously poured flexible single diving lip 12. Pin Weight 10 at this location will cause lure 30 to dive head first and being forward on the lure bottom surface 14, lure 30 tail portion 14a will exhibit a more active fish enticing side to side action. Optional treble hook 11 is suspended from tandem hook 60 eye 8 with an “O” ring 9. Fishing lure 40 in FIG. 4 is comprised of a two-hook tandem hook 60, front line eye 4, provided for fish line 53 snap 38. FIGS. 15, 15A, 15B and 15C, illustrate a two lipped interchangeable flexible or rigid accessory, having lips 15a and 16a and a tapered hole 63a to recess line hook eye 4 or Hook Apparatus 22 line attachment hole 23. Flange 33 receives hook shanks 5 and 6a and line eye 4. Hook shanks 5 and 6a are held firm by a Cotter pin 52 in hole 29. FIG. 4 exhibits a Pin Weight 10 inserted through bottom surface 18 of frog shaped bait 40, which stabilizes bait and keeps it from spinning, when trolling or retrieving a cast. Pin Float 10a will make lure 40 ride higher in the water. More Pin Floats 10a may make some lures 40 buoyant enough to float. Some Pin Weights 10 and Pin Floats 10a are equipped with a barb 67. FIG. 4 also shows two flexible planes 15 and 16 intersecting forming an angle between 75 degrees and 105 degrees. This angle provides means for water to pass lure 40 and cause controlled water disturbance in order to have an up and down frog like pulsating action. Intersecting flexible planes or blades 15 and 16 contain a large hole 63 at their intersection and bait vertical centerline. Hole 63 is provided to recess hook line eye 4, into the lure 40, in order to balance lures and increase the up and down action. Line eye 4, both hook shanks 5 and 6a penetrate lure body 40 at an upwardly angle from the bottom posterior end. Only hook 61 extends above lure 40 and contacts wire weed guard 170 loop 57. Weed guard 170 is inserted in to surface of lures 40, 90, and 160 at an angle, so that top legs 56 and 56a can be flexed to connect and maintain tension with hook barb 62. Legs 58 and 58a inserted in bait at a specific angle penetrate through bait 40 bottom surface 18, where they are bent to the rear and parallel to the bottom surface, forming portions 59 and 59a, securing and aligning the weed guard 170 to the hook barb. Flexible blades 15 and 16 bend back wards when contacting obstructions, such as reeds, brush, or rocks, allowing lure 40 to pass over and around the impediment. Frog shaped lure 40, having upper 15 and lower 16 intersecting planes has the up and down action enhanced by the proper placement of Pin Weight 10 or Pin Float 10a impaled into lure body, weight inserted in bottom 18. Relocating Pin weight 10 will increase or decrease lure action. Pin Weight inserted in lure 40 side will cause lure 40 to rotate 90 degrees to exhibit a side-to-side action instead of expected up and down motion. Shorter lures generally exhibit a quicker action. FIG. 7 illustrating a soft worm shaped body 47, impaled on front top hook 6 of a modified two hook tandem hook 120. Worm 47 is positioned to the rear of the diving lip 12, so that Pin Float 10a can be inserted at front end of worm 47 and be positioned over the permanently affixed single flexible diving lip 41a. 42a in FIG. 11 is rear extension of lip 41 is necessary to attach lip 41 securely to hook 120 and to insure proper action. Size of Pin Float 10a determines the depth lure 70 will run. In order to make a two hook tandem hook 60 more versatile, diving lips 32 and 32a were developed. They are secured by a cotter pin. 52 in hole 43 Hookmaster 50 is also made more versatile by developing flexible and rigid interchangeable single diving lips 32,and 32a. Holes 29 and 29b in blade flanges 33, 33a, 42, and 42a use the same holes 29 and 29b and cotter pin 52 for attachment. FIG. 13 shows a front view of lip 41 with hole 43 in upper portion. Flange fitting 42 has closed portion 35 at top of lip flange 42. Tandem hook 120, short angled bent front portion 13 is installed inside lip 41. Eye 4 penetrates through lip 41 on short horizontal leg 5a. Short angled portion 13 is behind lip 41, when used with tandem hook and interchangeable flexible single bladed accessory. Hook line eye 4 at end of short leg 5a of hook shank 5 penetrates single flexible or rigid lip 12, 32, 32a or 41. FIG. 14a shows side view of rigid lip 140a with hook attachment flange 33a having holes 29 and 29b, used to secure single or double hook shanks 5 and 6a and Hookmaster 2 with cotter pin 52. FIG. 14b shows slot 34a in top portion of lip 32 to receive front portion 39 of Hookmaster 50. To make lure 40 concept more versatile, a double bladed accessory 150 was developed. Said Accessory 150 consists of an upper blade 15a and lower blade 16a, which intersect at an acute angle ranging between 75 degrees and 105 degrees, 90-degree angle being the preferred. Hole 63a is provided through intersection of blades 15a and 16a.on bait vertical centerline. Depth of hole 63a is required to recess hook line eye 4 or Hookmaster 50 fishing line eyehole 23 helps to balance live or artificial baits and create a unique up and down action. Tandem Hook 60 or Hookmaster 50 is inserted through slot 43a in flange 42a and is secured by front bottom hook eye 24 and Cotter pin 52 through hole 29a. Hole 63a must be large enough to not interfere with the up and down motion of double loop accessory 37. Hookmaster 50 may be used with both single bladed 12 and double bladed accessory 150,by turning it up side down. FIG. 16 is a Hookmaster 20 attached to an interchangeable double bladed accessory 150, having bait aligning and securing hook 28, recessed hole 63a, back of hole 39a, and double loop accessory 67 attached to Hookmaster 20 hole 23a. Also showing universal hole 29 and 29b, along with cotter pin 52, which secures accessory 150 to Hookmaster 20. Curved upper front hook 6 and 6a impales soft artificial bait 160. Optional single separate hook 55 is attached to tandem hook 110 by an “O” ring 9 attached to hook eye 8. Pin Float 3b is inserted in front surface of bait 160 with pin 2. Wire weed guard 170 is bent into an acute angle. One end contains loop 57 connected to legs 56, which is flexed and held in tension at bottom of hook barb 62a, Pin Weight 10b having elongated body portion 1c or Pin Float with body 3d and pin 2b and 2c extending from either end. Said Pin Weight lob with bodies 1c or 3d are concealed in soft plastic bait, such as a worm 47, shown in FIG. 18 by slit 65. FIG. 18A shows Pin Float 3d partially concealed in worm body 47. Pin Float 3d can be sealed into slit 65 by passing a hot knife over incision 65 and melting material edges together.

The described drawings illustrates the invention. A Pin Weight, FIGS. 1A-1H and collectively referred to herein by the numeral 10 and Pin Float referred to by numeral 10a and shown in FIGS. 1I-1L show some of the various shapes available. Pin Float 10a are used to enhance the bait action to increase the possibilities of catching fish and to gain the satisfaction of using a Pin Weight 10 or a Pin Float 10a properly, that you have outsmarted the fish. A Pin Weight 10 is comprised of two parts, a straight pin, similar to a sewing pin, and a weight molded from Epoxy with environmentally friendly fillers of Iron Ferrite, Barium Sulfate, Zirconium Silicate, or other heavy material or from toxic molten metal, such as Lead. A Pin Float 10a, similar in shape to the Pin Weight 10 in FIGS. 1A-1H consists of the same straight pin 2 with Epoxy filled with micro balloons, ground cork, close cell foam, or other buoyant materials bonded to pin 2. Pin Weight 10 is inserted into soft plastic body 30 on the bottom surface 14 behind simultaneously poured flexible single diving lip 12. Pin Weight 10 at this location will cause lure 30 to dive head first and being forward on the lure bottom surface 14, lure 30 tail portion 14a will exhibit a more active fish enticing side to side action. Optional treble hook 11 is suspended from tandem hook 60 eye 8 with an “O” ring 9. Fishing lure 40 in FIG. 4 is comprised of a two-hook tandem hook 60, front line eye 4, provided for fish line 53 snap 38. FIGS. 15, 15A, 15B and 15C, illustrate a two lipped interchangeable flexible or rigid accessory, having lips 15a and 16a and a tapered hole 63a to recess line hook eye 4 or Hook Apparatus 22 line attachment hole 23. Flange 33 receives hook shanks 5 and 6a and line eye 4. Hook shanks 5 and 6a are held firm by a Cotter pin 52 in hole 29. FIG. 4 exhibits a Pin Weight 10 inserted through bottom surface 18 of frog shaped bait 40, which stabilizes bait and keeps it from spinning, when trolling or retrieving a cast. Pin Float 10a will make lure 40 ride higher in the water. More Pin Floats 10a may make some lures 40 buoyant enough to float. Some Pin Weights 10 and Pin Floats 10a are equipped with a barb 67. FIG. 4 also shows two flexible planes 15 and 16 intersecting forming an angle between 75 degrees and 105 degrees. This angle provides means for water to pass lure 40 and cause controlled water disturbance in order to have an up and down frog like pulsating action. Intersecting flexible planes or blades 15 and 16 contain a large hole 63 at their intersection and bait vertical centerline. Hole 63 is provided to recess hook line eye 4, into the lure 40, in order to balance lures and increase the up and down action. Line eye 4, both hook shanks 5 and 6a penetrate lure body 40 at an upwardly angle from the bottom posterior end. Only hook 61 extends above lure 40 and contacts wire weed guard 170 loop 57. Weed guard 170 is inserted in to surface of lures 40, 90, and 160 at an angle, so that top legs 56 and 56a can be flexed to connect and maintain tension with hook barb 62. Legs 58 and 58a inserted in bait at a specific angle penetrate through bait 40 bottom surface 18, where they are bent to the rear and parallel to the bottom surface, forming portions 59 and 59a, securing and aligning the weed guard 170 to the hook barb. Flexible blades 15 and 16 bend back wards when contacting obstructions, such as reeds, brush, or rocks, allowing lure 40 to pass over and around the impediment. Frog shaped lure 40, having upper 15 and lower 16 intersecting planes has the up and down action enhanced by the proper placement of Pin Weight 10 or Pin Float 10a impaled into lure body, weight inserted in bottom 18. Relocating Pin weight 10 will increase or decrease lure action. Pin Weight inserted in lure 40 side will cause lure 40 to rotate 90 degrees to exhibit a side-to-side action instead of expected up and down motion. Shorter lures generally exhibit a quicker action. FIG. 7 illustrating a soft worm shaped body 47, impaled on front top hook 6 of a modified two hook tandem hook 120. Worm 47 is positioned to the rear of the diving lip 12, so that Pin Float 10a can be inserted at front end of worm 47 and be positioned over the permanently affixed single flexible diving lip 41a. 42a in FIG. 11 is rear extension of lip 41 is necessary to attach lip 41 securely to hook 120 and to insure proper action. Size of Pin Float 10a determines the depth lure 70 will run. In order to make a two hook tandem hook 60 more versatile, diving lips 32 and 32a were developed. They are secured by a cotter pin. 52.in hole 43 Hookmaster 50 is also made more versatile by developing flexible and rigid interchangeable single diving lips 32,and 32a. Holes 29 and 29b in blade flanges 33, 33a, 42, and 42a use the same holes 29 and 29b and cotter pin 52 for attachment. FIG. 13 shows a front view of lip 41 with hole 43 in upper portion. Flange fitting 42 has closed portion 35 at top of lip flange 42. Tandem hook 120, short angled bent front portion 13 is installed inside lip 41. Eye 4 penetrates through lip 41 on short horizontal leg 5a. Short angled portion 13 is behind lip 41, when used with tandem hook and interchangeable flexible single bladed accessory. Hook line eye 4 at end of short leg 5a of hook shank 5 penetrates single flexible or rigid lip 12, 32, 32a or 41. FIG. 14a shows side view of rigid lip 140a with hook attachment flange 33a having holes 29 and 29b, used to secure single or double hook shanks 5 and 6a and Hookmaster 2 with cotter pin 52. FIG. 14b shows slot 34a in top portion of lip 32 to receive front portion 39 of Hookmaster 50. To make lure 40 concept more versatile, a double bladed accessory 150 was developed. Said Accessory 150 consists of an upper blade 15a and lower blade 16a, which intersect at an acute angle ranging between 75 degrees and 105 degrees, 90-degree angle being the preferred. Hole 63a is provided through intersection of blades 15a and 16a.on bait vertical centerline. Depth of hole 63a is required to recess hook line eye 4 or Hookmaster 50 fishing line eyehole 23 helps to balance live or artificial baits and create a unique up and down action. Tandem Hook 60 or Hookmaster 50 is inserted through slot 43a in flange 42a and is secured by front bottom hook eye 24 and Cotter pin 52 through hole 29a. Hole 63a must be large enough to not interfere with the up and down motion of double loop accessory37. Hookmaster 50 may be used with both single bladed 12 and double bladed accessory 150,by turning it up side down. FIG. 16 is a Hookmaster 20 attached to an interchangeable double bladed accessory 150, having bait aligning and securing hook 28, recessed hole 63a, back of hole 39a, and double loop accessory 67 attached to Hookmaster 20 hole 23a. Also showing universal hole 29 and 29b, along with cotter pin 52, which secures accessory 150 to Hookmaster 20. Curved upper front hook 6 and 6a impales soft artificial bait 160. Optional single separate hook 55 is attached to tandem hook 110 by an “O” ring 9 attached to hook eye 8. Pin Float 3b is inserted in front surface of bait 160 with pin 2. Wire weed guard 170 is bent into an acute angle. One end contains loop 57 connected to legs 56, which is flexed and held in tension at bottom of hook barb 62a, Pin Weight 10b having elongated body portion 1c or Pin Float with body 3d and pin 2b and 2c extending from either end. Said Pin Weight lob with bodies 1c or 3d are concealed in soft plastic bait, such as a worm 47, shown in FIG. 18 by slit 65. FIG. 18A shows Pin Float 3d partially concealed in worm body 47. Pin Float 3d can be sealed into slit 65 by passing a hot knife over incision 65 and melting material edges together.

What is claimed is:

1. the invention includes artificial fishing lures having optional means to cause lures to exhibit up and down and vertical oscillation. Such means include a Pin Weight consisting of a straight pin, similar to a sewing pin, having a weight material permanently formed of the blunt end and an acute angle bent on the opposite end. A similar shaped pin concept having buoyant material molded on the blunt pin end. Weight and buoyant materials are generally ball, elliptical, and flat shaped solids. A second concept includes weight and buoyant material molded on two separate projecting pins aligned in the same direction. A third concept includes and elongated weights and buoyant material having a single barbed pin extending form each end, front pin approximately twice as long as rear pin. Said Pin Weights and Pin Floats correctly inserted into live bait and artificial bait eliminates unwanted lure spin and determines, which end of the lure sinks first and that the lure runs correct side up. The lure of the invention a soft artificial frog shaped bait having two flexible intersecting planes, which form a horizontal “V” shape near front end of bait. Said flexible planes intersect form an angle ranging from 75 to 105 degrees, approximately 90 degrees being preferred. Rigid material is not necessary, as flexible material will provide the required action and the flexible lips will bend back when contacting an impediment, making the lures extremely foul resistant. A large hole is required near front end of lure on vertical centerline and intersection of the two angled lips. This large hole is necessary to center hook line eyelet and to eliminate any friction of lure with line snap. Two hook tandem hook and “Hookmaster” is inserted through hole in rear of bait, pushed slightly upward until line eyelet is centered in front large hole. A two-loop wire is preferred to make easy connection between line snap and hook to insure maximum lure action. Tandem hook with a single upwardly oriented fish catching hook is made weed free, by the addition of an optional stainless steel wire weed guard. Said weed guard consists of a loop with two wire legs extending from loop. Each wire has a barb bent at the ends and each wire leg has an obtuse bend. The barbed ends are inserted into live and artificial soft baits at such an angle that exterior portion of leg is placed under tension as loop is engaged with hook barb. This weed guard works equally well with side to side and up and down oscillating lures. Two flexible intersecting blades can be permanently attached to tandem hook and hook master. A second concept includes removable interchangeable intersecting blades and a single blade, which are attached to both tandem hooks and “Hookmasters”. Said blades activate many different shapes and sizes of live and soft artificial conventional baits.

2. The Pin Float of claim 1 further provides that more than one pin float will increase floatation so that lure action can occur on the water surface. Claim 3. The Pin weight and Pin Float of claim 1 further provides that a slit in soft artificial baits is provided to conceal elliptical weights and floats within said slit.

3. The Pin Weight of claim 1 further provides options for different environmentally friendly materials, including Epoxy filled with Barium Sulfate, Zirconium Silicate, and Iron Ferrite. The generally used weight material, lead, is toxic and is banned in many states.

4. The Pin Float of claim 1 further provides options for different floatation materials, including Epoxy filled with micro-balloons, close cell foam, and ground up cork, as examples.

5. The Pin Weights and Pin Floats of Claim further provides that inserting one or more Pin Weights and Pin Floats in side portion of lure having two flexible intersecting planes and exhibiting an up and down motion, will change oscillation to side to side.

6. The two hook tandem hook of claim 1 wherein the tandem hook, hook shanks, of both top and bottom hooks are straight and connected to form hook line eyelet. Hook line eyelet and both anterior hook shanks are inserted into lower rear portion of two bladed soft bait and exits at rear center of hole on vertical centerline near front of lure. This eyelet location is critical to insure maximum lure oscillation.

7. The lure of claim 1 wherein baits are designed in many shapes and sizes and from many materials and live baits can be impaled on single and double bladed accessories.

8. The tandem hook of claim 1 wherein tandem hook is versatile in that the fish catching hook can be a single hook oriented up, down, and optionally formed into an eyelet for optional fish hooks including treble, double, and single hooks.

9. The tandem hook of claim 1 further provides a feather jig with Pin Float inserted in front end and both interchangeable flexible and rigid single diving lips exhibit enticing side-to-side oscillation.

10. The lures of claim 1 wherein having flexible diving lip and weed less hook, stays weed free, as flexible lip bends back allowing lure to flip over and around an impediment.

11. The lures of claim 1 further provides that lure can be fished in reeds, brush, and rocks by inserting optional weed guard of the invention into proper place on soft lure body.

12. The Hookmaster of claim 1 further provides that front upper hook of Hookmaster is impaled into baits having both single and double intersecting lips.

13. The Hookmaster of claim 1 further provides holes for optional fishing hooks and interchangeable lips.

14. The Hookmaster of claim 1 further provides that projection on lower front portion contains fish line snap holes for both single and double bladed lures. Lower hole adds action to single bladed lures.

15. The double lipped accessory of claim 1 wherein both live and soft artificial conventional baits, without lips, can be impaled on said interchangeable accessory to effect an up and down oscillation.

16. The apparatus of claim 1 wherein the correct weight is placed on bait bottom surface to take lure deep and have no deleterious results to the up and down action.

17. The single and double lipped interchangeable accessories of claim 1 further provides that flexible and rigid blades can be easily be removed, replaced, and secured by cotter pin in provided holes.

18. The tandem hook of claim 1 further provides an eyelet on front portion of bottom hook shank, having a dual purpose, to restrict double bladed accessory from sliding back and also used to suspend optional fish hooks

19. The single blade accessory of claim 1 further provides that hole in rear bottom portion of single bladed accessory; rear flange lower hole is used to attach Hookmaster.
